(19) United States
(12) Patent Application Publication
(10) Pub. No.: US 2014/0008566 A1
(43) Pub. Date: Jan. 9, 2014

(54) PRODUCING METHOD OF THERMALLY CONDUCTIVE SHEET AND THERMALLY CONDUCTIVE SHEET

(71) Applicants: Hisae Kitagawa, Osaka (JP); Seiji Izutani, Osaka (JP); Takahiro Fukuoka, Osaka (JP); Miho Yamaguchi, Osaka (JP)

(72) Inventors: Hisae Kitagawa, Osaka (JP); Seiji Izutani, Osaka (JP); Takahiro Fukuoka, Osaka (JP); Miho Yamaguchi, Osaka (JP)

(73) Assignee: NITTO DENKO CORPORATION, Ibaraki-shi, Osaka (JP)

(21) Appl. No.: 14/006,013

(22) PCT Filed: Mar. 15, 2012
(86) PCT No.: PCT/JP2012/056682

§ 371 Date: Sep. 18, 2013

(30) Foreign Application Priority Data
Mar. 30, 2011 (JP) 2011-076542

(51) Int. Cl. B29C 51/18; C09K 5/14

(52) U.S. Cl. CPC B29C 51/18; C09K 5/14
USPC 252/74; 264/322

(57) ABSTRACT

A method for producing a thermally conductive sheet, having a thermal conductivity in a direction perpendicular to a thickness direction of 10 W/m·K or more, includes a preparing step of preparing a resin composition containing a resin and a thermally conductive inorganic particle and a sheet forming step of forming a sheet by further increasing the viscosity after hot-pressing the resin composition to be brought from a melted state into a semi-solid state.

### TECHNICAL FIELD

The present invention relates to a method for producing a thermally conductive sheet and a thermally conductive sheet, to be specific, to a method for producing a thermally conductive sheet used for power electronics technology and a thermally conductive sheet obtained by the method for producing a thermally conductive sheet.

### BACKGROUND ART

In recent years, power electronics technology that uses a semiconductor element to convert and control electric power is applied in a hybrid device, a high-brightness LED device, an electromagnetic induction heating device, and the like. In the power electronics technology, a high current is converted to heat or the like and thus, a material that is disposed near the semiconductor element is required to have excellent heat dissipating properties (excellent thermally conductive properties).

For example, a thermally conductive sheet containing a boron nitride powder in a plate shape and an acrylic acid ester copolymer resin has been proposed (ref: for example, Patent Document 1).

In the thermally conductive sheet in Patent Document 1, the boron nitride powder is oriented so that its long axis direction (a direction perpendicular to the plate thickness of the boron nitride powder) is along the thickness direction of the sheet and in this way, the thermally conductive properties in the thickness direction of the thermally conductive sheet is improved.

### PRIOR ART DOCUMENT

### Patent Document

Patent Document 1: Japanese Unexamined Patent Publication No. 2008-280496

### SUMMARY OF THE INVENTION

### Problems to be Solved by the Invention

There may be a case where, however, the thermally conductive sheet is required to have high thermally conductive properties in a direction perpendicular to the thickness direction (a plane direction) in accordance with its use and purpose. In such a case, there is a disadvantage that in the thermally conductive sheet in Patent Document 1, the long axis direction of the boron nitride powder is perpendicular to (crossing) the plane direction, so that the thermally conductive properties in the plane direction are insufficient.

In the thermally conductive sheet, a pore is easily generated in the inside thereof and the pore may cause a reduction in various electrical properties such as a reduction in thermally conductive properties and a reduction in dielectric strength (dielectric breakdown voltage).

It is an object of the present invention to provide a thermally conductive sheet that has excellent thermally conductive properties in the plane direction and in which a pore in the inside thereof is reduced and a producing method thereof.

### Solution to the Problems

A method for producing a thermally conductive sheet of the present invention, having a thermal conductivity in a direction perpendicular to a thickness direction of 10 W/m·K or more, includes a preparing step of preparing a resin composition containing a resin and a thermally conductive inorganic particle and a sheet forming step of forming a sheet by further increasing the viscosity after hot-pressing the resin composition to be brought from a melted state into a semi-solid state.

According to the method for producing a thermally conductive sheet, by hot-pressing the resin composition, the thermally conductive inorganic particle is capable of being dispersed in a state of being oriented in a predetermined direction and the viscosity is increased in such a state, so that a pore in the sheet is capable of being reduced.

As a result, according to the method for producing a thermally conductive sheet, a thermally conductive sheet having excellent thermally conductive properties in the plane direction perpendicular to the thickness direction and furthermore, having excellent various electrical properties such as the dielectric strength (the dielectric breakdown voltage) is capable of being produced.

In the method for producing a thermally conductive sheet, a pore in the sheet is reduced, so that a step such as defoaming is not required and thus, the thermally conductive sheet is capable of being produced with less number of steps and lower cost.

In the method for producing a thermally conductive sheet of the present invention, it is preferable that the sheet forming step includes a melting step of hot-pressing the resin composition under the heating and pressurizing conditions in which the resin is hot-melted and a retaining step of, after the melting step, lowering the temperature to the temperature at which the resin is hardly moved, while retaining the resin composition in a pressurized state down to the temperature.

In the method for producing a thermally conductive sheet, in the retaining step, the temperature is lowered to the temperature at which the resin is hardly moved, while the resin composition that is hot-melted in the melting step is retained in a pressurized state down to the temperature, so that the orientational properties of the thermally conductive inorganic particle are increased and a pore in the sheet is capable of being reduced.

As a result, according to the method for producing a thermally conductive sheet, a thermally conductive sheet having more excellent thermally conductive properties in the plane direction perpendicular to the thickness direction and having more excellent various electrical properties such as the dielectric strength (the dielectric breakdown voltage) is capable of being produced.

In the method for producing a thermally conductive sheet of the present invention, it is preferable that in the melting step, the hot-pressing is performed so that the viscosity of the resin is less than 5000 mPa·s and in the retaining step, the sheet is retained until the viscosity of the resin is 5000 mPa·s or more.

According to the method for producing a thermally conductive sheet, the sheet that is hot-pressed in the melting step so that the viscosity of the resin is less than 5000 mPa·s is retained in the retaining step so that the viscosity thereof is 5000 mPa·s or more and thus, the orientational properties of the thermally conductive inorganic particle are further increased and a pore in the sheet is capable of being further reduced.

As a result, according to the method for producing a thermally conductive sheet, a thermally conductive sheet having more excellent thermally conductive properties in the plane direction perpendicular to the thickness direction and having more excellent various electrical properties such as the dielectric strength (the dielectric breakdown voltage) is capable of being produced.

In the method for producing a thermally conductive sheet of the present invention, it is preferable that the thermally conductive inorganic particle is a particle in a flake shape having an average primary particle size of 10 μm or more and the resin composition contains the thermally conductive particle at a ratio of 40 volume % or more with respect to the total amount thereof.

According to the method for producing a thermally conductive sheet, the thermally conductive inorganic particle in a flake shape having an average primary particle size of 10 μm or more is contained in the resin composition at a ratio of 40 volume % or more, so that the excellent thermally conductive properties are capable of being ensured.

A thermally conductive sheet of the present invention is obtained by the above-described method for producing a thermally conductive sheet, wherein the porosity is 30 volume % or less.

The thermally conductive sheet is obtained by the above-described method and the porosity is 30 volume % or less, so that it has excellent thermally conductive properties in the plane direction perpendicular to the thickness direction and has excellent various electrical properties such as the dielectric strength (the dielectric breakdown voltage).

### Effect of the Invention

In the method for producing a thermally conductive sheet of the present invention, a thermally conductive sheet having excellent thermally conductive properties in the plane direction perpendicular to the thickness direction and having excellent various electrical properties such as the dielectric strength (the dielectric breakdown voltage) is capable of being obtained.

In the method for producing a thermally conductive sheet of the present invention, a pore in the sheet is reduced, so that a step such as defoaming is not required and thus, the thermally conductive sheet is capable of being produced with less number of steps and lower cost.

The thermally conductive sheet of the present invention is capable of being used for various heat dissipating use as a thermally conductive sheet having excellent thermally conductive properties in the plane direction perpendicular to the thickness direction and having excellent various electrical properties such as the dielectric strength (the dielectric breakdown voltage).

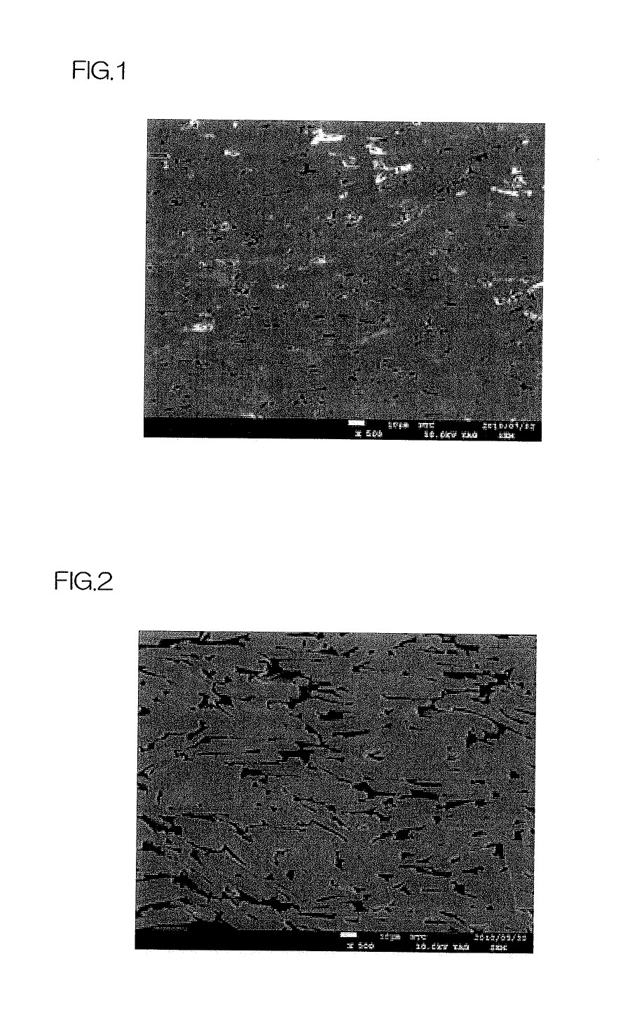

### BRIEF DESCRIPTION OF THE DRAWINGS

[FIG. 1] shows a processed SEM image of a cross section along the thickness direction of a thermally conductive sheet in Example 1.

[FIG. 2] shows a processed SEM image of a cross section along the thickness direction of a thermally conductive sheet in Comparative Example 1.

### EMBODIMENT OF THE INVENTION

In a method for producing a thermally conductive sheet of the present invention, first, a resin composition containing a resin and thermally conductive inorganic particles is prepared (a preparing step).

The resin is a component that is capable of dispersing the thermally conductive inorganic particles, that is, a dispersion medium (matrix) in which the thermally conductive inorganic particles are dispersed. The resin is not particularly limited as long as it is a resin that generates a viscosity change in a sheet forming step to be described later. An example thereof includes a resin component such as a thermosetting resin component and a thermoplastic resin component.

Examples of the thermosetting resin component include an epoxy resin, a thermosetting polyimide, a phenol resin, a urea resin, a melamine resin, an unsaturated polyester resin, a diallyl phthalate resin, a silicone resin, and a thermosetting urethane resin.

Examples of the thermoplastic resin component include a polyolefin (for example, a polyethylene, a polypropylene, and an ethylene-propylene copolymer), an acrylic resin (for example, a polymethyl methacrylate), a polyvinyl acetate, an ethylene-vinyl acetate copolymer, a polyvinyl chloride, a polystyrene, a polyacrylonitrile, a polyamide (nylon (registered trademark)), a polycarbonate, a polyacetal, a polyethylene terephthalate, a polyphenylene oxide, a polyphenylene sulfide, a polysulfone, a polyether sulfone, a poly ether ether ketone, a polyallyl sulfone, a thermoplastic polyimide, a thermoplastic urethane resin, a polyamino-bismaleimide, a polyamide imide, a polyether imide, a bismaleimide triazine resin, a polymethylpentene, a fluorine resin, a liquid crystal polymer, an olefin-vinyl alcohol copolymer, an ionomer, a polyarylate, an acrylonitrile-ethylene-styrene copolymer, an acrylonitrile-butadiene-styrene copolymer, and an acrylonitrile-styrene copolymer.

These resins can be used alone or in combination of two or more.

Of the resins, as the thermosetting resin component, preferably, an epoxy resin is used and as the thermoplastic resin component, preferably, a polyolefin is used.

The epoxy resin is in a state of liquid, semi-solid, or solid at a normal temperature.

To be specific, examples of the epoxy resin include an aromatic epoxy resin such as a bisphenol epoxy resin (for example, a bisphenol A epoxy resin, a bisphenol F epoxy resin, a bisphenol S epoxy resin, a hydrogenated bisphenol A epoxy resin, and a dimer acid-modified bisphenol epoxy resin), a novolak epoxy resin (for example, a phenol novolak epoxy resin, a cresol novolak epoxy resin, and a biphenyl epoxy resin), a naphthalene epoxy resin, a fluorene epoxy resin (for example, a bisaryl fluorene epoxy resin), and a triphenylmethane epoxy resin (for example, a trishydroxyphenylmethane epoxy resin); a nitrogen-containing-cyclic epoxy resin such as a triepoxypropyl isocyanurate (a triglycidyl isocyanurate) and a hydantoin epoxy resin; an aliphatic epoxy resin; an alicyclic epoxy resin (for example, a dicyclo ring-type epoxy resin); a glycidylether epoxy resin; and a glycidylamine epoxy resin.

These epoxy resins can be used alone or in combination of two or more.

Preferably, an epoxy resin in a semi-solid state is used alone, or more preferably, an aromatic epoxy resin in a semi-solid state is used alone. To be more specific, an example of the epoxy resin includes a fluorene epoxy resin in a semi-solid state.

Preferably, an epoxy resin in a liquid state and an epoxy resin in a solid state are used in combination. More preferably, an aromatic epoxy resin in a liquid state and an aromatic epoxy resin in a solid state are used in combination. Examples of the combination include combination of a bisphenol epoxy resin in a liquid state and a triphenylmethane epoxy resin in a solid state and combination of a bisphenol epoxy resin in a liquid state and a bisphenol epoxy resin in a solid state.

The epoxy resin has an epoxy equivalent of, for example, 100 to 1000 g/eqiv., or preferably 180 to 700 g/eqiv. and has a softening temperature (a ring and ball test) of, for example, 80° C. or less (to be specific, 20 to 80° C.), or preferably 70° C. or less (to be specific, 35 to 70° C.).

The epoxy resin has a melt viscosity at 80° C. of, for example, 10 to 20000 mPa·s, or preferably 50 to 10000 mPa·s. When the epoxy resins are used in combination of two or more, the melt viscosity of the mixture of these epoxy resins is set within the above-described range.

Furthermore, when the epoxy resins are used in combination of two or more, for example, an epoxy resin in a solid state at a normal temperature and an epoxy resin in a liquid state at a normal temperature are used in combination. Furthermore, when the epoxy resins are used in combination of two or more, a first epoxy resin having a softening temperature of, for example, less than 45° C., or preferably 35° C. or less and a second epoxy resin having a softening temperature of, for example, 45° C. or more, or preferably 55° C. or more are used in combination. In this way, the kinetic viscosity (in conformity with JIS K 7233, described later) of the resin (mixture) can be set to a desired range.

When the two types of epoxy resins (the first epoxy resin and the second epoxy resin) are used in combination, the mass ratio (the mass of the first epoxy resin/the mass of the second epoxy resin) of the first epoxy resin to the second epoxy resin can be appropriately set in accordance with the softening temperature or the like of each of the epoxy resins (the first epoxy resin and the second epoxy resin) and is, for example, 1/99 to 99/1, or preferably 10/90 to 90/10.

The epoxy resin can be also prepared as an epoxy resin composition by containing, for example, a curing agent and a curing accelerator.

The curing agent is a latent curing agent (an epoxy resin curing agent) that is capable of curing the epoxy resin by heating. Examples thereof include an imidazole compound, an amine compound, an acid anhydride compound, an amide compound, a hydrazide compound, and an imidazoline compound. In addition to the above-described compounds, examples thereof also include a phenol compound, a urea compound, and a polysulfide compound.

Examples of the imidazole compound include a 2-phenyl imidazole, a 2-methyl imidazole, a 2-ethyl-4-methyl imidazole, and a 2-phenyl-4-methyl-5-hydroxymethyl imidazole.

Examples of the amine compound include a polyamine such as an ethylene diamine, a propylene diamine, a diethylene triamine, and a triethylene tetramine and amine adducts thereof; a metha phenylenediamine; a diaminodiphenyl methane; and a diaminodiphenyl sulfone.

Examples of the acid anhydride compound include a phthalic anhydride, a maleic anhydride, a tetrahydrophthalic anhydride, a hexahydrophthalic anhydride, a 4-methyl-hexahydrophthalic anhydride, a methyl nadic anhydride, a pyromellitic anhydride, a dodecenylsuccinic anhydride, a dichloro succinic anhydride, a benzophenone tetracarboxylic anhydride, and a chlorendic anhydride.

Examples of the amide compound include a dicyandiamide and a polyamide.

An example of the hydrazide compound includes an adipic acid dihydrazide.

Examples of the imidazoline compound include a methyl imidazoline, a 2-ethyl-4-methyl imidazoline, an ethyl imidazoline, an isopropyl imidazoline, a 2,4-dimethyl imidazoline, a phenyl imidazoline, an undecyl imidazoline, a heptadecyl imidazoline, and a 2-phenyl-4-methyl imidazoline.

These curing agents can be used alone or in combination of two or more.

As the curing agent, preferably, an imidazole compound is used.

Examples of the curing accelerator include a tertiary amine compound such as a triethylenediamine and a tri-2,4,6-dimethylaminomethylphenol; a phosphorus compound such as a triphenylphosphine, a tetraphenylphosphoniumtetraphenylborate, and a tetra-n-butylphosphonium-o,o-diethylphosphorodithioate; a quaternary ammonium salt compound; an organic metal salt compound; and derivatives thereof. These curing accelerators can be used alone or in combination of two or more.

In the epoxy resin composition, the mixing ratio of the curing agent with respect to 100 parts by mass of the epoxy resin is, for example, 0.5 to 50 parts by mass, or preferably 1 to 10 parts by mass and the mixing ratio of the curing accelerator with respect to 100 parts by mass of the epoxy resin is, for example, 0.1 to 10 parts by mass, or preferably 0.2 to 5 parts by mass.

The above-described curing agent and/or curing accelerator can be used by being prepared as a solvent solution and/or a solvent dispersion liquid obtained by being dissolved and/or dispersed with the solvent as required.

An example of the solvent includes an organic solvent such as ketone including acetone and methyl ethyl ketone, ester including ethyl acetate, and amide including N,N-dimethylformamide. An example of the solvent also includes an aqueous solvent such as water and an alcohol including methanol, ethanol, propanol, and isopropanol. As the solvent, preferably, an organic solvent is used, or more preferably, ketone is used.

As the polyolefin, preferably, a polyethylene and an ethylene-propylene copolymer are used.

Examples of the polyethylene include a low density polyethylene and a high density polyethylene.

Examples of the ethylene-propylene copolymer include a random copolymer, a block copolymer, or a graft copolymer of ethylene and propylene.

These polyolefins can be used alone or in combination of two or more.

The polyolefin has a weight average molecular weight and/or a number average molecular weight of, for example, 1000 to 10000.

The polyolefin has a melting point of, for example, 80° C. or less (to be specific, 20 to 80° C.), or preferably 70° C. or less (to be specific, 35 to 70° C.).

These polyolefins can be used alone or in combination of two or more.

Of the resins, preferably, a thermosetting resin component is used, or more preferably, an epoxy resin is used.

The resin contains, for example, a polymer precursor (for example, a low molecular weight polymer containing an oligomer) and/or a monomer, in addition to the above-described components (polymers).

The resin has a viscosity at a room temperature (25° C.) of, for example, 3000 mPa·s or more and less than 30000 mPa·s, or preferably 5000 mPa·s or more and less than 20000 m.

As described above, the resin has a melting temperature (a softening temperature (a ring and ball test) when the resin is a thermosetting resin component and a melting point when the resin is a thermoplastic resin component) of, for example, 80° C. or less (to be specific, 20 to 80° C.), or preferably 70° C. or less (to be specific, 35 to 70° C.).

The thermally conductive inorganic particles are not particularly limited as long as they are uniformly dispersed in the resin and, as described later, a thermally conductive sheet having a thermal conductivity in a direction perpendicular to the thickness direction of 10 W/m·K or more is capable of being produced. A known filler can be used as the thermally conductive inorganic particles.

To be specific, examples of the thermally conductive inorganic particles include oxide particles such as aluminum oxide, silicon dioxide, titanium dioxide, mica, potassium titanate, iron oxide, and talc; nitride particles such as boron nitride, silicon nitride, and aluminum nitride; carbide particles such as silicon carbide; and metal particles such as copper and aluminum.

These thermally conductive inorganic particles can be used alone or in combination of two or more.

As the thermally conductive inorganic particles, preferably, nitride particles are used, or more preferably, boron nitride is used.

Examples of a shape of each of the thermally conductive inorganic particles include a plate shape, a flake shape, and a sphere shape. Preferably, a plate shape and a flake shape are used, or more preferably, a flake shape is used.

Each of the thermally conductive inorganic particles in a flake shape (or in a plate shape, hereinafter the same) has an average length in the longitudinal direction (the maximum length in a direction perpendicular to the thickness direction of the flake) of, for example, 1 to 100 μm, or preferably 3 to 90 μm. Each of the thermally conductive inorganic particles has an average length in the longitudinal direction of, 5 μm or more, preferably 10 μm or more, more preferably 20 μm or more, particularly preferably 30 μm or more, or most preferably 40 μm or more, and usually of, for example, 100 μm or less, or preferably 90 μm or less.

Each of the thermally conductive inorganic particles has an average thickness (the length in the thickness direction of the flake, that is, the length in the short-side direction of the particle) of, for example, 0.01 to 20 μm, or preferably 0.1 to 15 μm.

The aspect ratio (the length in the longitudinal direction/the thickness) of each of the thermally conductive inorganic particles is, for example, 2 to 10000, or preferably 10 to 5000.

Each of the boron nitride particles has an average primary particle size measured by a light scattering method, of, for example, 5 μm or more, preferably 10 μm or more, more preferably 20 μm or more, particularly preferably 30 μm or more, or most preferably 40 μm or more, and usually of 100 μm or less.

The average primary particle size measured by the light scattering method is a volume average particle size measured with a dynamic light scattering type particle size distribution analyzer.

When the average primary particle size of the thermally conductive inorganic particles measured by the light scattering method is below the above-described range, there may be a case where the thermally conductive sheet becomes fragile and the handling ability thereof is reduced.

The thermally conductive inorganic particles have a bulk density (JIS K 5101, the apparent density) of, for example, 0.3 to 1.5 g/cm³, or preferably 0.5 to 1.0 g/cm³.

As the thermally conductive inorganic particles, a commercially available product or processed goods thereof can be used.

An example of the commercially available product includes a commercially available product of the boron nitride particles. To be specific, examples of the commercially available product of the boron nitride particles include the “PT” series (for example, “PT-110”) manufactured by Momentive Performance Materials Inc. and the “SHOBN UHP” series (for example, “SHOBN UHP-1”) manufactured by Showa Denko K.K.

In the resin composition, the content ratio of the thermally conductive inorganic particles based on volume (the solid content, that is, when the resin is made of a thermoplastic resin component, the volume percentage of the thermally conductive inorganic particles with respect to the total volume of the thermoplastic resin component and the thermally conductive inorganic particles) is, 35 volume % or more, preferably 40 volume % or more, more preferably 65 volume % or more, or further more preferably 75 volume % or more, and is usually, for example, 95 volume % or less.

When the content proportion of the thermally conductive inorganic particles based on volume is below the above-described range, there may be a case where the thermally conductive inorganic particles are not capable of being oriented in a predetermined direction in the thermally conductive sheet. On the other hand, when the content proportion of the thermally conductive inorganic particles based on volume is above the above-described range, there may be a case where the thermally conductive sheet becomes fragile and the handling ability thereof is reduced.

The mixing ratio of the thermally conductive inorganic particles based on mass with respect to 100 parts by mass of the total amount (the total amount of the solid content) of the components (the thermally conductive inorganic particles and the resin) that form the thermally conductive sheet is, for example, 40 to 95 parts by mass, or preferably 65 to 90 parts by mass and the mixing ratio of the resin based on mass with respect to 100 parts by mass of the total amount of the components that form the thermally conductive sheet is, for example, 5 to 60 parts by mass, or preferably 10 to 35 parts by mass. The mixing ratio of the thermally conductive inorganic particles based on mass with respect to 100 parts by mass of the resin is, for example, 60 to 1900 parts by mass, or preferably 185 to 900 parts by mass.

In the preparation of the resin composition, though not particularly limited, the above-described resin (the curing agent, the curing accelerator, and the solvent as required) and the thermally conductive inorganic particles are blended at the above-described proportion and are stirred and mixed by a known method.

In the stirring and mixing, in order to mix the components efficiently, for example, the solvent is blended therein with the above-described components or, for example, the resin (preferably, a thermoplastic resin component) can be melted by heating.

An example of the solvent includes the same organic solvent as that described above. When the above-described curing agent and/or curing accelerator are/is prepared as a solvent solution and/or a solvent dispersion liquid, the solvent of the solvent solution and/or the solvent dispersion liquid can also serve as a mixed solvent for the stirring and mixing without adding a solvent during the stirring and mixing. Alternatively, in the stirring and mixing, a solvent can be further added as a mixed solvent.

When the stirring and mixing is performed using a solvent, the solvent is removed after the stirring and mixing.

In order to remove the solvent, the mixture is, for example, allowed to stand at a room temperature for 1 to 48 hours; for example, is heated at 40 to 100° C. for 0.5 to 3 hours; or, for example, is heated under a reduced pressure atmosphere of 0.001 to 50 kPa at 20 to 60° C. for 0.5 to 3 hours.

When the resin (preferably, a thermoplastic resin component) is melted by heating, the heating temperature is, for example, a temperature near or exceeding the softening temperature of the resin, to be specific, 40 to 200° C., or preferably 70 to 140° C.

In this way, a resin composition is prepared.

In the present invention, the resin composition that is prepared in the preparing step is in a state of solid or semi-solid at a room temperature (25° C.).

Next, in this method, the obtained resin composition is hot-pressed, the resin composition is brought from a melted state into a semi-solid state, and thereafter, the viscosity of the resin composition is further increased, so that the resin composition is formed into a sheet (a sheet forming step).

To be more specific, in the sheet forming step, first, the resin composition is hot-pressed via two release films under the heating and pressurizing conditions in which the resin is hot-melted (a melting step).

The conditions of the hot-pressing are not limited as long as the resin is hot-melted. To be specific, the conditions are as follows: a temperature of, for example, 50 to 150° C., or preferably 60 to 140° C. and a pressure of, for example, 1 to 100 MPa, or preferably 5 to 50 MPa.

Preferably, the resin composition is hot-pressed under vacuum. The degree of vacuum in the vacuum hot-pressing is, for example, 1 to 100 Pa, or preferably 5 to 50 Pa, and the temperature, the pressure, and the duration are the same as those in the above-described hot-pressing.

When the temperature, the pressure, and/or the duration in the hot-pressing is outside the above-described range, there may be a case where a porosity P (described later) of the thermally conductive sheet is not capable of being adjusted to a desired value.

In the melting step, the resin composition is hot-pressed so that the viscosity of the resin is, for example, less than 10000 mPa·s, or preferably less than 5000 mPa·s, and is usually 50 mPa·s or more.

In the melting step, when the resin is a thermosetting resin component, the resin is once brought into a melted state by the hot-pressing and thereafter, the curing is progressed by heating to bring the resin into a semi-solid state (a B-stage state).

When the resin is a thermoplastic resin component, the resin is brought into a melted state by the hot-pressing.

Next, in the sheet forming step, after the above-described melting step, the temperature is lowered to the temperature at which the resin is hardly moved, while the resin composition is retained in a pressurized state down to the temperature (a retaining step).

To be specific, in the retaining step, under the above-described pressurizing conditions, the resin composition is retained in a pressurized state and is cooled to the temperature at which the resin is hardly moved, so that the viscosity of the resin composition is increased (a thickening step) to bring the resin composition into a solid state (a solidifying step).

When the thermosetting resin component is used as the resin, for example, the temperature at which the resin is hardly moved is, for example, 0 to 150° C., or preferably 5 to 100° C.

When the thermoplastic resin component is used as the resin, the temperature at which the resin is hardly moved is, for example, 0 to 150° C., or preferably 5 to 100° C.

The resin composition is cooled to the above-described temperature under the above-described pressurizing conditions, so that the viscosity of the resin composition (a pressed sheet) is increased and the resin is hardly moved, so that the pressed sheet in which the resin composition is almost solidified is obtained.

When the resin is the thermosetting resin component, by cooling, physical solidification is progressed due to a reduction in temperature, while the progress of curing is suppressed, and as a result, the resin composition is almost solidified.

When the resin is the thermoplastic resin component, by cooling, physical solidification is progressed due to a reduction in temperature and the resin composition is almost solidified via a semi-solid state.

In this way, in the retaining step, the temperature is lowered to the temperature at which the resin is hardly moved, while the resin composition that is hot-melted in the melting step is retained in a pressurized state down to the temperature, so that the orientational properties of the thermally conductive inorganic particles are increased and pores in the sheet are capable of being reduced.

In the retaining step, the retaining duration in which the resin composition is retained in a pressurized state is, for example, 5 minutes to 3 hours, or preferably 15 minutes to 1 hour.

The viscosity of the resin after increase (the viscosity in a state where the resin is hardly moved) is, for example, 3000 mPa·s or more, or preferably 5000 mPa·s or more, and is, usually, less than 30000 mPa·s, or preferably less than 20000 mPa·s.

When the sheet that is hot-pressed in the melting step so that the viscosity of the resin is less than 5000 mPa·s is retained in the retaining step so that the viscosity thereof is 5000 mPa·s or more, the orientational properties of the thermally conductive inorganic particles are further increased and pores in the sheet are capable of being further reduced.

According to the method for producing a thermally conductive sheet, by hot-pressing the resin composition, the thermally conductive inorganic particles are capable of being dispersed in a state of being oriented in a predetermined direction and the viscosity is increased in such a state, so that pores in the sheet are capable of being reduced.

As a result, according to the method for producing a thermally conductive sheet, a thermally conductive sheet having excellent thermally conductive properties in the plane direction perpendicular to the thickness direction and having excellent various electrical properties such as the dielectric strength (the dielectric breakdown voltage) is capable of being produced.

In addition, in the method for producing a thermally conductive sheet, pores in the sheet are reduced, so that a step such as defoaming is not required and thus, the thermally conductive sheet is capable of being produced with less number of steps and lower cost.

The thermally conductive sheet (the pressed sheet) obtained in this way has a thickness of, for example, 50 to 1000 μm, or preferably 100 to 800 μm.

The content ratio of the thermally conductive inorganic particles based on volume in the thermally conductive sheet (the solid content, that is, the volume percentage of the thermally conductive inorganic particles with respect to the total volume of the resin and the thermally conductive inorganic particles) is, as described above, 35 volume % or more, preferably 40 volume % or more, more preferably 65 volume % or more, or further more preferably 75 volume % or more, and is usually, for example, 95 volume % or less.

When the content proportion of the thermally conductive inorganic particles is below the above-described range, there may be a case where the thermally conductive inorganic particles are not capable of being oriented in a predetermined direction in the thermally conductive sheet.

In the thermally conductive sheet obtained in this way, the longitudinal direction of the thermally conductive inorganic particles is oriented along the plane direction that crosses (is perpendicular to) the thickness direction of the thermally conductive sheet.

The calculated average of the angle formed between the longitudinal direction of the thermally conductive inorganic particles and the plane direction of the thermally conductive sheet (an orientation angle of the thermally conductive inorganic particles with respect to the thermally conductive sheet) is, for example, 25 degrees or less, or preferably 20 degrees or less, and is usually 0 degree or more.

The orientation angle of the thermally conductive inorganic particles with respect to the thermally conductive sheet is obtained as follows: the thermally conductive sheet is cut along the thickness direction with a cross section polisher (CP); the cross section thus appeared is photographed with a scanning electron microscope (SEM) at a magnification that enables observation of 200 or more thermally conductive inorganic particles in the field of view; a tilt angle between the longitudinal direction of the thermally conductive inorganic particles and the plane direction (a direction perpendicular to the thickness direction) of the thermally conductive sheet is obtained from the obtained SEM photograph; and the average value of the tilt angles is calculated.

In this way, the thermally conductive sheet has a thermal conductivity in the plane direction of 10 W/m·K or more, or preferably 20 W/m·K or more, and usually of, 200 W/m·K or less.

When the thermal conductivity in the plane direction of the thermally conductive sheet is below the above-described range, the thermally conductive properties in the plane direction are insufficient, so that the thermally conductive sheet is not capable of being used for heat dissipating use that requires the thermally conductive properties in such a plane direction SD.

The thermal conductivity in the plane direction of the thermally conductive sheet is measured by a pulse heating method. In the pulse heating method, a xenonflash analyzer “LFA-447” (manufactured by Erich NETZSCH GmbH & Co. Holding KG) is used.

The thermally conductive sheet has a thermal conductivity in the thickness direction of, for example, 0.5 to 15 W/m·K, or preferably 1 to 10 W/m·K.

The thermal conductivity in the thickness direction of the thermally conductive sheet is measured by a pulse heating method, a laser flash method, or a TWA method. In the pulse heating method, the above-described device is used; in the laser flash method, “TC-9000” (manufactured by Ulvac, Inc.) is used; and in the TWA method, “ai-Phase mobile” (manufactured by ai-Phase Co., Ltd) is used.

In this way, the ratio (the thermal conductivity in the plane direction/the thermal conductivity in the thickness direction) of the thermal conductivity in the plane direction of the thermally conductive sheet with respect to the thermal conductivity in the thickness direction of the thermally conductive sheet is, for example, 1.5 or more, preferably 3 or more, or more preferably 4 or more, and is usually 20 or less.

In the thermally conductive sheet, for example, pores (gaps) are formed.

The proportion of the pores in the thermally conductive sheet, that is, the porosity P, can be adjusted by setting the content proportion of the thermally conductive inorganic particles (based on volume); furthermore, by setting the temperature, the pressure, and/or the duration at the time of the hot-pressing of the resin composition containing the thermally conductive inorganic particles and the resin; and furthermore, by setting the retaining duration under the pressurizing conditions. To be specific, the porosity P can be adjusted by setting the temperature, the pressure, and/or the duration of the above-described hot-pressing within the above-described range.

The porosity P of the thermally conductive sheet is, for example, 30 volume % or less, or preferably 10 volume % or less.

The above-described porosity P is measured by, for example, as follows: first, the thermally conductive sheet is cut along the thickness direction with a cross section polisher (CP); the cross section thus appeared is observed with a scanning electron microscope (SEM) at a magnification of 200 to obtain an image; the obtained image is binarized based on a pore portion and a non-pore portion; and next, the area ratio of the pore portion with respect to the total area of the cross section of the thermally conductive sheet is calculated.

The thermally conductive sheet is obtained by the above-described method and the porosity is 30 volume % or less, so that it has excellent thermally conductive properties in the plane direction perpendicular to the thickness direction and has excellent various electrical properties such as the dielectric strength (the dielectric breakdown voltage).

Thus, the thermally conductive sheet is capable of being used for various heat dissipating use as a thermally conductive sheet having excellent thermally conductive properties in the plane direction perpendicular to the thickness direction and having excellent various electrical properties such as the dielectric strength (the dielectric breakdown voltage).

In the thermally conductive sheet, when the resin is a thermosetting resin component, the thermally conductive sheet that is almost solidified at the time of its use is capable of being cured by heating.

In order to cure the thermally conductive sheet by heating, the above-described hot-press or an oven is used. Preferably, an oven is used. The conditions of the curing by heating are as follows: a temperature of, for example, 60 to 250° C., or preferably 80 to 200° C. When the hot-press is used, the pressure is, for example, 100 MPa or less, or preferably 50 MPa or less.

The thermal conductivity in the plane direction of the thermally conductive sheet is, when the resin is the thermosetting resin component, substantially the same before and after the curing by heating.

In the thermally conductive sheet, a porosity P2 after curing with respect to a porosity P1 before curing is, for example, 100% or less, or preferably 50% or less.

The thermally conductive sheet is capable of being used for various heat dissipating use as a thermally conductive sheet having excellent thermally conductive properties in the plane direction perpendicular to the thickness direction and having excellent various electrical properties such as the dielectric strength (the dielectric breakdown voltage).

To be specific, the thermally conductive sheet can be used as a thermally conductive sheet applied in power electronics technology, to be more specific, as a thermally conductive sheet used as, for example, an LED heat dissipating substrate or as a heat dissipating material for batteries.

### EXAMPLES

In the following, the present invention will now be described in more detail by way of Examples and Comparative Examples. However, the present invention is not limited to the following Examples and Comparative Examples.

### Example 1

As thermosetting resin components, 1 g of jER 828 (manufactured by Japan Epoxy Resins Co., Ltd.) and 2 g of EPPN-501HY (manufactured by NIPPON KAYAKU Co., Ltd.), which were an epoxy monomer; 3 g of a methyl ethyl ketone solution with a concentration of 5 mass % of Curezol 2P4 MHZ-PW (manufactured by Shikoku Chemicals Corporation), which was an imidazole epoxy resin curing agent; and 12 g of PT-110 (manufactured by Momentive Performance Materials Inc.), which was a boron nitride filler, were mixed and stirred, so that a resin composition was prepared (a preparing step).

Next, the obtained resin composition was allowed to stand under a room temperature (25° C.) atmosphere for one night and the methyl ethyl ketone was volatilized. Thereafter, the resin composition was sandwiched between silicone-treated release films to be pressurized using a vacuum hot-press machine at 110° C. under the vacuum conditions of 10 Pa with a load of 5 tons for 10 minutes (a melting step).

Thereafter, the pressure (5 tons) was retained and the temperature in the press machine was lowered to 50° C., so that the viscosity of the resin was increased (a retaining step). Thereafter, the sheet was taken out from the press machine and a thermally conductive sheet that was almost solidified was obtained (a sheet forming step).

The content ratio of the boron nitride in the obtained thermally conductive sheet was 70 volume %.

### Example 2

As thermosetting resin components, 1 g of OGSOL EG-200 (manufactured by Osaka Gas Chemicals Co., Ltd.) and 2 g of EPPN-501HY (manufactured by NIPPON KAYAKU Co., Ltd.), which were an epoxy monomer; 3 g of a methyl ethyl ketone solution with a concentration of 5 mass % of Curezol 2P4 MHZ-PW (manufactured by Shikoku Chemicals Corporation), which was an imidazole epoxy resin curing agent; and 12 g of PT-110 (manufactured by Momentive Performance Materials Inc.), which was a boron nitride filler, were mixed and stirred, so that a resin composition was prepared (a preparing step).

Next, the obtained resin composition was allowed to stand under a room temperature (25° C.) atmosphere for one night and the methyl ethyl ketone was volatilized. Thereafter, the resin composition was sandwiched between silicone-treated release films to be pressurized using a vacuum hot-press machine at 110° C. under the vacuum conditions of 10 Pa with a load of 5 tons for 10 minutes (a melting step).

Thereafter, the pressure (5 tons) was retained and the temperature in the press machine was lowered to 50° C., so that the viscosity of the resin was increased (a retaining step). Thereafter, the sheet was taken out from the press machine and a thermally conductive sheet that was almost solidified was obtained (a sheet forming step).

The content ratio of the boron nitride in the obtained thermally conductive sheet was 70 volume %.

### Example 3

As a thermoplastic resin component, 1 g of polyethylene (manufactured by Sigma-Aldrich Co. LLC.) was hot-melted at 130° C. Then, 3 g of PT-110 (manufactured by Momentive Performance Materials Inc.), which was a boron nitride filler, was mixed thereto and stirred, so that a resin composition was prepared (a preparing step).

Next, the obtained resin composition was sandwiched between silicone-treated release films to be pressurized using a vacuum hot-press machine at 110° C. under the vacuum conditions of 10 Pa with a load of 5 tons for 10 minutes (a melting step).

Thereafter, the pressure (5 tons) was retained and the temperature in the press machine was lowered to 50° C., so that the viscosity of the resin was increased (a retaining step). Thereafter, the sheet was taken out from the press machine and a thermally conductive sheet that was solidified was obtained (a sheet forming step).

The content ratio of the boron nitride in the obtained thermally conductive sheet was 70 volume %.

### Comparative Example 1

As thermosetting resin components, 1 g of jER 828 (manufactured by Japan Epoxy Resins Co., Ltd.) and 2 g of EPPN-501HY (manufactured by NIPPON KAYAKU Co., Ltd.), which were an epoxy monomer; 3 g of a methyl ethyl ketone solution with a concentration of 5 mass % of Curezol 2P4 MHZ-PW (manufactured by Shikoku Chemicals Corporation), which was an imidazole epoxy resin curing agent; and 12 g of PT-110 (manufactured by Momentive Performance Materials Inc.), which was a boron nitride filler, were mixed and stirred, so that a resin composition was prepared.

Next, the obtained resin composition was allowed to stand under a room temperature (25° C.) atmosphere for one night and the methyl ethyl ketone was volatilized. Thereafter, the resin composition was sandwiched between silicone-treated release films to be pressurized using a vacuum hot-press machine at 110° C. under the vacuum conditions of 10 Pa with a load of 5 tons for 10 minutes. Then, the sheet was taken out from the press machine without retaining the pressurized state, so that a thermally conductive sheet was obtained.

The content ratio of the boron nitride in the obtained thermally conductive sheet was 70 volume %.

### Comparative Example 2

As a thermoplastic resin component, 1 g of polyethylene (manufactured by Sigma-Aldrich Co. LLC.) was hot-melted at 130° C. Then, 3 g of PT-110 (manufactured by Momentive Performance Materials Inc.), which was a boron nitride filler, was mixed thereto and stirred, so that a resin composition was prepared (a preparing step).

Next, the obtained resin composition was sandwiched between silicone-treated release films to be pressurized using a vacuum hot-press machine at 110° C. under the vacuum conditions of 10 Pa with a load of 5 tons for 10 minutes. Then, the sheet was taken out from the press machine without retaining the pressurized state, so that a thermally conductive sheet was obtained.

The content ratio of the boron nitride in the obtained thermally conductive sheet was 70 volume %.

(Evaluation)

(1) Thermal Conductivity

The thermal conductivity in the plane direction of each of the thermally conductive sheets obtained in Examples and Comparative Examples was measured by a pulse heating method using a xenon flash analyzer “LFA-447” (manufactured by Erich NETZSCH GmbH & Co. Holding KG).

The results are shown in Table 1.

(2) Viscosity of Resin

The viscosity of each of the resins used in Examples and Comparative Examples at the time of hot-pressing and that of each of the resins used in Examples and Comparative Examples at the time of being taken out from the press machine were measured, respectively, using a B-type viscometer (model number: TV-20, manufactured by TOKI SANGYO CO., LTD.).

The results are shown in Table 1.

In Example 3 and Comparative Example 2 in which the thermoplastic resin component was used, the resin composition was brought into a liquid state at the time of the hot-pressing, so that the viscosity was not capable of being measured and the thermally conductive sheet was solidified after the hot-pressing, so that the viscosity was not capable of being measured.

TABLE 1

| | Viscosity of Resin (mPa · s) | | |
|---|---|---|---|
| Ex. Comp. | At Time of | At Time of | Thermal Conductivity |
| Ex. No. | Hot-Pressing | Being Taken Out | (W/m · K) |
| Ex. 1 | 160 | 10000 | 40 |
| Ex. 2 | 791 | >100000 | 49 |
| Ex. 3 | Unmeasurable | Unmeasurable | 63 |
| Comp. Ex. 1 | 160 | 160 | 34 |
| Comp. Ex. 2 | Unmeasurable | Unmeasurable | 18 |

(3) Porosity

Each of the thermally conductive sheets obtained in Example 1 and Comparative Example 1 was cut along the thickness direction with a cross section polisher (CP) and the cross section thus appeared was observed with a scanning electron microscope (SEM) at a magnification of 200.

The processed image of the thermally conductive sheet in Example 1 is shown in FIG. 1 and that of the thermally conductive sheet in Comparative Example 1 is shown in FIG. 2.

In FIGS. 1 and 2, it was confirmed that in the thermally conductive sheet in Example 1 that was formed into a sheet by further increasing the viscosity after hot-pressing the resin composition to be brought from a melted state into a semi-solid state, pores in the sheet are reduced, compared to the thermally conductive sheet in Comparative Example 1 that was formed into a sheet without increasing the viscosity.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The thermally conductive sheet of the present invention is effectively used in the field in which the power electronics technology is applied.

1. A method for producing a thermally conductive sheet, having a thermal conductivity in a direction perpendicular to a thickness direction of 10 W/m·K or more, comprising:
a preparing step of preparing a resin composition containing a resin and a thermally conductive inorganic particle and
a sheet forming step of forming a sheet by further increasing the viscosity after hot-pressing the resin composition to be brought from a melted state into a semi-solid state.

2. The method for producing a thermally conductive sheet according to claim 1, wherein
the sheet forming step includes
a melting step of hot-pressing the resin composition under the heating and pressurizing conditions in which the resin is hot-melted and
a retaining step of, after the melting step, lowering the temperature to the temperature at which the resin is hardly moved, while retaining the resin composition in a pressurized state down to the temperature.

3. The method for producing a thermally conductive sheet according to claim 2, wherein
in the melting step,
the hot-pressing is performed so that the viscosity of the resin is less than 5000 mPa·s and
in the retaining step,
the sheet is retained until the viscosity of the resin is 5000 mPa·s or more.

4. The method for producing a thermally conductive sheet according to claim 1, wherein
the thermally conductive inorganic particle is a particle in a flake shape having an average primary particle size of 10 μm or more and
the resin composition contains the thermally conductive particle at a ratio of 40 volume % or more with respect to the total amount thereof.

5. A thermally conductive sheet obtained by a method for producing a thermally conductive sheet, wherein
the method for producing a thermally conductive sheet, having a thermal conductivity in a direction perpendicular to a thickness direction of 10 W/m·K or more, comprises:
a preparing step of preparing a resin composition containing a resin and a thermally conductive inorganic particle and
a sheet forming step of forming a sheet by further increasing the viscosity after hot-pressing the resin composition to be brought from a melted state into a semi-solid state, and
the porosity is 30 volume % or less.
